(19) United States
(12) Patent Application Publication
(10) Pub. No.: US 2026/0070163 A1
(43) Pub. Date: Mar. 12, 2026

(54) SOLID WIRE AND GAS SHIELDED ARC WELDING METHOD

(71) Applicants: KABUSHIKI KAISHA KOBE SEIKO SHO (KOBE STEEL, LTD.), Kobe-shi (JP); JGC CORPORATION, Yokohama-shi (JP)

(72) Inventors: Shinya ISONO, Kanagawa (JP); Hideaki TAKAUCHI, Kanagawa (JP); Atsushi TAKAHASHI, Kanagawa (JP)

(73) Assignees: KABUSHIKI KAISHA KOBE SEIKO SHO (KOBE STEEL, LTD.), Kobe-shi (JP); JGC CORPORATION, Yokohama-shi (JP)

(21) Appl. No.: 19/108,457

(22) PCT Filed: Jul. 28, 2023
(86) PCT No.: PCT/JP2023/027875

§ 371 Date: Mar. 4, 2025

(30) Foreign Application Priority Data
Sep. 7, 2022 (JP) 2022-142294

(51) Int. Cl. B23K 35/30; B23K 9/16; B23K 35/02; B23K 103/04; C22C 38/00; C22C 38/02; C22C 38/04; C22C 38/06; C22C 38/42; C22C 38/44; C22C 38/46; C22C 38/48; C22C 38/50; C22C 38/52

(52) U.S. Cl. CPC B23K 35/3086; B23K 9/16; B23K 35/0261; C22C 38/001; C22C 38/002; C22C 38/02; C22C 38/04; C22C 38/06; C22C 38/42; C22C 38/44; C22C 38/46; C22C 38/48; C22C 38/50; C22C 38/52; B23K 2103/04

(57) ABSTRACT

A solid wire capable of obtaining back beads with excellent appearance and a weld metal with excellent mechanical performance without using a backing gas. The solid wire is used for welding a steel material that contains 4 mass % or more and 10 mass % or less of Cr. The solid wire contains, based on a total mass of the wire, C: 0.02 mass % or more and 0.11 mass % or less; Si: 0.6 mass % or more and 1.7 mass % or less; Mn: 0.2 mass % or more and 1.5 mass % or less; S: more than 0.005 mass % and 0.030 mass % or less; Cr: 4.0 mass % or more and 13 mass % or less; Mo: 0.3 mass % or more and 1.5 mass % or less; P: 0.030 mass % or less; Ni: 1.4 mass % or less; Nb: 0.05 mass % or less; V: 0.05 mass % or less; Ti: 0.05 mass % or less; and Al: 0.05 mass % or less, with the remainder being Fe and unavoidable impurities.

### TECHNICAL FIELD

The present invention relates to a solid wire and a gas shielded arc welding method.

### BACKGROUND ART

In the fields of petroleum refining plants and petrochemical plants, steels containing Cr are used to withstand harsh environments. Generally, when gas shielded arc welding is performed on steel materials with a high content of Cr as single welded butt joints, in order to prevent poor appearance of beads generated by back bead welding due to formation of Cr oxides with a high melting point on a back bead surface, back shielding with an inert gas is required for the first layer of welding. However, continuously flowing a backing gas from a back side of a steel material increases a cost and makes the work complicated when the target steel material is, for example, a pipe material.

Patent Literature 1 discloses a welding material that can produce welds having excellent back bead performance and mechanical performance without using a backing gas. In the welding material described in Patent Literature 1, contents of C, Cr, Mo, Ni and Al are specified, and a relation between the contents of Cr and Mn and a content of Si, a relation between a content of S and a content of Mn, and a total amount of the content of Al and a content of O are controlled, and the contents of P and S in impurities are specified.

### CITATION LIST

### Patent Literature

Patent Literature 1: JPH10-24388A

### SUMMARY OF INVENTION

### Technical Problem

A weld metal may be subjected to a post weld heat treatment (PWHT) for a purpose of improving toughness and the like. However, in the welding material described in Patent Literature 1, a high temperature transformation temperature (Ac1 transformation point) has not been considered, and depending on a temperature of the PWHT, the toughness of the weld metal may not be ensured. There is also room for further improvement in the back bead performance and the mechanical performance of the first layer.

The present invention has been made in view of the above-mentioned circumstances, and an object thereof is to provide a solid wire and a gas shielded arc welding method that can be used for welding in which at least one of steel materials to be welded contains 4 mass % or more and 10 mass % or less of Cr, and that can obtain back beads with excellent appearance and a weld metal with excellent mechanical performance without using a backing gas.

### Solution to Problem

As a result of diligent research to solve the above problems, the present inventors have found that in order to prevent occurrence of poor formation of back beads, it is particularly important to control contents of Si, S, and the like in a solid wire. The present invention was made based on this finding.

The above object of the present invention is achieved by the following configuration [1] according to the solid wire.

[1] A solid wire for welding steel materials to be welded, in which at least one of the steel materials is a steel material containing 4 mass % or more and 10 mass % or less of Cr, the solid wire containing, based on a total mass of the wire:
C: 0.02 mass % or more and 0.11 mass % or less;
Si: 0.6 mass % or more and 1.7 mass % or less;
Mn: 0.2 mass % or more and 1.5 mass % or less;
S: more than 0.005 mass % and 0.030 mass % or less;
Cr: 4.0 mass % or more and 13 mass % or less;
Mo: 0.3 mass % or more and 1.5 mass % or less;
P: 0.030 mass % or less;
Ni: 1.4 mass % or less;
Nb: 0.05 mass % or less;
V: 0.05 mass % or less;
Ti: 0.05 mass % or less; and
Al: 0.05 mass % or less,
with the remainder being Fe and unavoidable impurities.

A preferred embodiment of the solid wire according to the present invention relates to the following [2] and [3].

[2] The solid wire according to [1], further containing, based on the total mass of the wire:
Zr: 0.15 mass % or less.

[3] The solid wire according to [1] or [2], further containing:
at least one selected from Co, Cu and N in ranges of, based on the total mass of the wire,
   Co: 0.5 mass % or less,
   Cu: 0.5 mass % or less, and
   N: 0.02 mass % or less.

The above object of the present invention is achieved by the following configuration [4] according to a gas shielded arc welding method.

[4] A gas shielded arc welding method includes welding steel materials, at least one of which contains 4 mass % or more and 10 mass % or less of Cr, with the solid wire according to any one of [1] to [3], without using a backing gas.

### Advantageous Effects of Invention

The present invention can provide a solid wire capable of obtaining back beads with excellent appearance and a weld metal with excellent mechanical performance without using a backing gas, and a gas shielded arc welding method using the solid wire.

### DESCRIPTION OF EMBODIMENTS

Hereinafter, an embodiment of the present invention will be described in detail. Note that in the present specification, a solid wire may be simply referred to as a “wire”. The present invention is not limited to the embodiment described below, and can be optionally modified and implemented without departing from the gist of the present invention.

### [Solid Wire]

A solid wire according to the present embodiment is used for welding steel materials to be welded in which at least one of the steel materials is a steel material containing 4 mass % or more and 10 mass % or less of Cr. The steel materials to be welded refer to a plurality of steel materials to be welded. For example, when the solid wire of the present embodiment is used for welding a pair of butt-jointed steel materials, a content of Cr of at least one of the pair of steel materials must be 4 mass % or more and 10 mass % or less. In other words, both of the pair of steel materials may contain Cr in the range of 4 mass % or more and 10 mass % or less, or the content of Cr of one of the pair of steel materials is 4 mass % or more and 10 mass % or less, and a content of Cr of the other steel material may be not particularly limited and may be outside the range of 4 mass % or more and 10 mass % or less. Note that the content of Cr of the other steel material is preferably 10 mass % or less (including 0 mass %). As the pair of steel materials, for example, a combination of a 9% Cr steel and a 2% Cr steel, or a combination of a 9% Cr steel and a steel material to be welded described in JIS G 3106 can be used to constitute the steel materials to be welded. The solid wire according to the present embodiment can also be applied to dissimilar material joints as described above.

Hereinafter, a steel having a content of Cr of 4 mass % or more and 6 mass % or less will be referred to as a 5% Cr steel, and a steel having a content of Cr of 8 mass % or more and 10 mass % or less will be referred to as a 9% Cr steel. In the present embodiment, a shape of the steel material used as the steel material to be welded is not particularly limited, and the present invention can be applied to welding, for example, steel plates, steel pipes, and the like.

Chemical components contained in the solid wire according to the present embodiment will be described in detail below with respect to reasons for containing and reasons for limiting numerical values thereof.

### <C: 0.02 Mass % or More and 0.11 Mass % or Less>

C is an important element that combines with Cr and Mo to form carbides and has an effect of ensuring strength of a weld metal. Furthermore, as an austenite forming element, C contributes to preventing formation of 8 ferrite in the weld metal. If a content of C is less than 0.02 mass % based on a total mass of the wire, desired strength of the weld metal cannot be obtained. Therefore, the content of C based on the total mass of the wire is 0.02 mass % or more, preferably 0.03 mass % or more, more preferably 0.04 mass % or more, and still more preferably 0.05 mass % or more.

On the other hand, if the content of C based on the total mass of the wire exceeds 0.11 mass %, a solidification temperature of a segregation portion is greatly lowered, and hot cracks are likely to occur. In addition, the strength of the weld metal becomes excessive, raising concerns about sulfide stress cracking. Furthermore, carbides precipitation becomes excessive, reducing toughness of the weld metal. Therefore, the content of C based on the total mass of the wire is 0.11 mass % or less, preferably 0.105 mass % or less, and more preferably 0.10 mass % or less.

### <Si: 0.6 Mass % or More and 1.7 Mass % or Less>

Silicon preferentially forms an oxide film on a back bead surface, which has a low melting point and is unlikely to inhibit solidification of the weld metal, and has the effect of preventing poor back bead formation due to oxidation of Cr during welding. If a content of Si based on the total mass of the wire is less than 0.6 mass %, the above-mentioned effects cannot be sufficiently obtained, and a back bead shape deteriorates. Therefore, the content of Si based on the total mass of the wire is 0.6 mass % or more, preferably 0.8 mass % or more, and more preferably 0.9 mass % or more.

On the other hand, if the content of Si exceeds 1.7 mass % based on the total mass of the wire, an excessive amount of 8 ferrite is formed in the weld metal, and the toughness of the weld metal decreases. In addition, an amount of slag generated on surface beads increases, making slag inclusion more likely to occur. Therefore, the content of Si based on the total mass of the wire is 1.7 mass % or less, preferably 1.6 mass % or less, and more preferably 1.5 mass % or less.

### <Mn: 0.2 Mass % or More and 1.5 Mass % or Less>

Mn is an element that functions as a deoxidizing agent for the weld metal and has an effect of improving the strength and toughness of the weld metal. Furthermore, as an austenite forming element, Mn contributes to preventing formation of the 8 ferrite in the weld metal. If a content of Mn based on the total mass of the wire is less than 0.2 mass %, insufficient deoxidation is caused and the effect of reducing residual 8 ferrite in the weld metal cannot be sufficiently obtained, resulting in a decrease in the toughness of the weld metal. Therefore, the content of Mn based on the total mass of the wire is 0.2 mass % or more, preferably 0.3 mass % or more, and more preferably 0.4 mass % or more.

On the other hand, if the content of Mn based on the total mass of the wire exceeds 1.5 mass %, high-temperature strength of the weld metal deteriorates. The solidification temperature of the segregation portion is also lowered, and a transformation point is also lowered, which makes it difficult to perform PWHT at a high temperature. Furthermore, a complex oxide with Cr will be generated, causing poor formation of the back beads. Therefore, the content of Mn based on the total mass of the wire is 1.5 mass % or less, preferably 1.3 mass % or less, and more preferably 1.1 mass % or less.

<S: More than 0.005 Mass % and 0.030 Mass % or Less>

S has an effect of affecting convection in a molten pool, increasing a penetration depth, improving arc stability, and forming good back beads. If a content of S based on the total mass of the wire is 0.005 mass % or less, poor penetration occurs and the back bead shape deteriorates. Therefore, the content of S based on the total mass of the wire is more than 0.005 mass %, preferably 0.006 mass % or more, and more preferably 0.007 mass % or more.

On the other hand, if the content of S exceeds 0.030 mass % based on the total mass of the wire, there is a concern that hot cracks may occur. Therefore, the content of S based on the total mass of the wire is 0.030 mass % or less, preferably 0.025 mass % or less, and more preferably 0.020 mass % or less.

### <Cr: 4.0 Mass % or More and 13 Mass % or Less>

In welding using the solid wire according to the present embodiment, Cr is a major element of the 5% Cr steel or the 9% Cr steel, which is at least one of the steel materials to be welded, and is an essential element for ensuring oxidation resistance at a high temperature and high-temperature strength of the weld metal. If a content of Cr based on the total mass of the wire is less than 4.0 mass %, the oxidation resistance and high-temperature strength of the weld metal become insufficient. Therefore, the content of Cr based on the total mass of the wire is 4.0 mass % or more, preferably 4.2 mass % or more, and more preferably 4.5 mass % or more.

On the other hand, if the content of Cr exceeds 13 mass % based on the total mass of the wire, even if the content of Si is controlled as described above, an oxide film that inhibits uniform solidification of the weld metal with a high melting point is formed on the back bead surface. Cr is a ferrite forming element and thus causes 8 ferrite to remain, deteriorating the toughness and creep performance of the weld metal. Therefore, the content of Cr based on the total mass of the wire is 13 mass % or less, preferably 12 mass % or less, and more preferably 11 mass % or less.

### <Mo: 0.3 Mass % or More and 1.5 Mass % or Less>

Mo is a solid-solution hardening element and also has an effect of improving the high-temperature strength by precipitating carbides. If a content of Mo based on the total mass of the wire is less than 0.3 mass %, the high-temperature strength of the weld metal becomes insufficient. Therefore, the content of Mo based on the total mass of the wire is 0.3 mass % or more, preferably 0.35 mass % or more, and more preferably 0.4 mass % or more.

On the other hand, if the content of Mo exceeds 1.5 mass % based on the total mass of the wire, it causes the 8 ferrite to remain, and the toughness and creep performance of the weld metal deteriorate. Therefore, the content of Mo based on the total mass of the wire is 1.5 mass % or less, preferably 1.3 mass % or less, and more preferably 1.2 mass % or less.

### <P: 0.030 Mass % or Less>

P is an impurity element and is a component that increases hot cracking susceptibility. If a content of P exceeds 0.030 mass % based on the total mass of the wire, there is a concern that hot cracks may occur. Therefore, the content of P based on the total mass of the wire is set to 0.030 mass % or less, preferably 0.020 mass % or less, and more preferably 0.015 mass % or less.

### <Ni: 1.4 Mass % or Less>

Ni, as Mn, is an austenite forming element and contributes to preventing formation of the 8 ferrite in the weld metal. In the present embodiment, a lower limit of a content of Ni is not particularly limited and may be 0 mass %. However, when Ni is contained in the wire for the purpose of preventing the formation of the 8 ferrite in the weld metal, the content of Ni based on the total mass of the wire is preferably 0.05 mass % or more, and more preferably 0.10 mass % or more.

On the other hand, if the content of Ni exceeds 1.4 mass % based on the total mass of the wire, the high-temperature strength of the weld metal deteriorates. The transformation point is also lowered, making PWHT at a high temperature difficult. Therefore, the content of Ni based on the total mass of the wire is 1.4 mass % or less, preferably 1.2 mass % or less, and more preferably 1.0 mass % or less.

### <Nb: 0.05 Mass % or Less>

Nb is a solid-solution hardening element, but when Nb is contained in an excessive amount in the wire, nitrides are precipitated, and the strength of the weld metal becomes excessively high. Nb also causes 8 ferrite to remain, which significantly deteriorates the toughness of the weld metal. If a content of Nb exceeds 0.05 mass % based on the total mass of the wire, the toughness of the weld metal deteriorates. Therefore, the content of Nb based on the total mass of the wire is 0.05 mass % or less, preferably 0.03 mass % or less, and more preferably 0.02 mass % or less.

### <V: 0.05 Mass % or Less>

When V is contained in an excessive amount in the wire, carbonitrides are precipitated, causing 8 ferrite to remain, and deteriorating the toughness of the weld metal. If the content of V exceeds 0.05 mass % based on the total mass of the wire, the toughness of the weld metal deteriorates. Therefore, the content of V based on the total mass of the wire is 0.05 mass % or less, preferably 0.03 mass % or less, and more preferably 0.02 mass % or less.

### <Ti: 0.05 Mass % or Less>

Ti forms an oxide film that inhibits uniform solidification of the weld metal and deteriorates the formation of a good back bead shape. If a content of Ti exceeds 0.05 mass % based on the total mass of the wire, the back bead shape deteriorates. Therefore, the content of Ti based on the total mass of the wire is 0.05 mass % or less, preferably 0.03 mass % or less, and more preferably 0.02 mass % or less.

### <Al: 0.05 Mass % or Less>

Al, as Si, is an element that preferentially forms an oxide film on the back bead surface, which has a low melting point and is unlikely to inhibit the solidification of the weld metal. However, since Al has a high slag generating ability, there is a concern that Al may cause slag inclusion. If a content of Al exceeds 0.05 mass % based on the total mass of the wire, slag inclusion is likely to occur. Therefore, the content of Al based on the total mass of the wire is 0.05 mass % or less, preferably 0.03 mass % or less, and more preferably 0.02 mass % or less.

The solid wire according to the present embodiment may contain Zr, Cu, Co, and N in addition to the above components. Contents of components that the wire may further contain and reasons for limiting the contents thereof will be described below.

### <Zr: 0.15 Mass % or Less>

Zr, as Si, is an element that preferentially forms an oxide film on the back bead surface, which is unlikely to inhibit the solidification of the weld metal. Therefore, it is preferable to contain Zr in the solid wire according to the present embodiment as necessary. If a content of Zr in the wire is in a range of 0.15 mass % or less, poor formation of the back beads due to oxidation of Cr during welding can be prevented without reducing the toughness due to excessive generation of 8 ferrite. Therefore, if Zr is contained in the solid wire according to the present embodiment, the content of Zr based on the total mass of the wire is preferably 0.15 mass % or less. If Zr is contained, the content thereof is preferably 0.005 mass % or more, and more preferably 0.010 mass % or more.

### <Co: 0.5 Mass % or Less, Cu: 0.5 Mass % or Less, N: 0.02 Mass % or Less>

Co, Cu and N are all austenite forming elements as Ni and Mn, and are elements that contribute to preventing the formation of 8 ferrite in the weld metal. In order to obtain desired mechanical performance of the weld metal by preventing the formation of 8 ferrite, the solid wire according to the present embodiment may contain at least one selected from Co, Cu, and N as necessary. Therefore, it is preferable to contain at least one selected from Co, Cu and N in ranges of Co: 0.5 mass % or less, Cu: 0.5 mass % or less, and N: 0.02 mass % or less, based on the total mass of the wire. Note that a content of Co is more preferably 0.40 mass % or less, and still more preferably 0.30 mass % or less. A content of Cu is more preferably 0.40 mass % or less, and still more preferably 0.30 mass % or less. A content of N is more preferably 0.015 mass % or less, and still more preferably 0.010 mass % or less.

If Co is contained in the wire, the content of Co is preferably 0.05 mass % or more, and more preferably 0.10 mass % or more. If Cu is contained in the wire, the content of Cu is preferably 0.05 mass % or more, and more preferably 0.10 mass % or more. If N is contained in the wire, the content of N is preferably 0.002 mass % or more, and more preferably 0.005 mass % or more. Note that the wire of the present embodiment may be plated with Cu, and the content of Cu includes an amount of copper plating.

### <Remainder: Fe and Unavoidable Impurities>

The remainder of the solid wire according to the present embodiment is Fe and unavoidable impurities. The unavoidable impurities refer to those that are not intentionally added to the wire, and examples of elements other than those mentioned above include B, Sn, As, and Sb. A total content of the impurities in the solid wire is preferably 0.10 mass % or less, and more preferably 0.05 mass % or less.

### [Gas Shielded Arc Welding Method]

The gas shielded arc welding method according to the present embodiment is a welding method for welding a steel material having a content of Cr of 4 mass % or more and 10 mass % or less, using the above-mentioned solid wire without using a backing gas. As described above, when a solid wire in the related art is used for welding a steel material containing 4 mass % to 10 mass % of Cr, the back beads are easily oxidized, and the shape and appearance of the back beads deteriorate. However, by using the solid wire according to the present embodiment for at least the first layer of welding, back beads having excellent back bead performance and mechanical performance can be formed without using a backing gas.

Note that in the gas shielded arc welding method according to the present embodiment, the type of welding is not particularly limited, and in addition to tungsten inert gas (TIG) welding, metal active gas (MAG) welding and metal inert gas (MIG) welding can be used.

### <Type and Flow Rate of Shielding Gas>

When welding with the solid wire according to the present embodiment, a shielding gas used on a front side is not particularly limited, and for example, Ar gas, carbon dioxide gas, a mixed gas of Ar gas and carbon dioxide gas, or a mixed gas of Ar gas and oxygen gas can be used. A flow rate of the gas is not particularly limited, and may be, for example, 15 L/min to 50 L/min.

### <Welding Position, Wire Diameter>

A welding position when using the solid wire according to the present embodiment is not particularly limited, and welding can be performed in various welding positions. Furthermore, a wire diameter (diameter) of the solid wire according to the present embodiment is not particularly limited, and can be applied to wires having diameters specified in welding material standards such as AWS or JIS.

### EXAMPLES

Hereinafter, effects of the present invention will be specifically described with reference to inventive examples and comparative examples according to the present invention, but the present invention is not limited thereto.

### [Production of Solid Wire]

Solid wires were prepared so that the components contained in the wires had various contents. The contents (mass %) of the chemical components per total mass of the wire are shown in Tables 1 and 2 below. Note that the remainder of the wires, excluding the chemical components shown in Tables 1 and 2 below, is Fe and unavoidable impurities. In Tables 1 and 2, “-” means that the component is not intentionally contained.

### [Gas Shielded Arc Welding (for Back Bead Evaluation)]

Welding was carried out for back bead evaluation. Specifically, a pair of steel plates having a plate thickness of 19 mm to 25 mm, a content of Cr of 9 mass %, a content of Mo of 1 mass %, and a groove angle of 70° were prepared, and the first layer was formed by TIG welding. Welding conditions are as follows.

### <Welding Conditions>

Welding method: TIG welding
Wire diameter: 2.4 mm
Root gap: 2 mm to 3 mm
Welding current: 90 A to 110 A
Arc voltage: 10 V to 14 V
Preheat: 150° C. to 300° C.
Shielding gas type and flow rate: 100% Ar, 15 L/min
Backing gas: None
Welding position: Flat

### [Back Bead Evaluation Test]

For the weld metal obtained using each solid wire, a back side of welding (back bead appearance) was visually observed, and cross-sectional macrograph of the weld metal was visually observed to evaluate the back beads. With respect to the back side of welding, the shape of the back beads, the degree of oxidation, the presence or absence of burn-through, and the presence or absence of concave beads were observed. With respect to the cross-sectional macrograph observation, the height of the back beads, the depth of depression in the back beads, and the shape of a boundary between the base material and the back bead were observed.

Note that for the back bead appearance, the back beads having a uniform width, free of meandering or unevenness, having no discoloration or unevenness due to oxidation, and having no burn-through or concave beads were judged as being good (pass). On the other hand, the back beads having uneven widths and a lot of unevenness, discolored or being uneven due to oxidation, or with burn-through or concave beads were to be judged as fail.

In the cross-sectional macrograph observation, a test piece with a back bead height of 1 mm or more was judged as pass, and a test piece with a back bead height of less than 1 mm was judged as fail. A test piece having a depression with a depth of less than 0.5 mm on a back side of the base material near the ends in the width direction of the back beads was judged as pass, and a test piece having a depression with a depth of 0.5 mm or more was judged as fail.

Furthermore, the shape of the boundary between the base material and the back bead was observed in the cross-sectional macrograph, and a test piece that had a gentle convex shape from the base materials to the back beads was judged as being good (pass), and a test piece in which the back beads rise sharply at the boundary between the base materials and the back bead was judged as being bad (fail). Note that in cases where burn-through occurs, the back beads tend to rise sharply and form a convex shape at the boundary between the base material and the back bead.

In the back bead evaluation, a test piece that passes all of the above items was given a grade of “A”, and a test piece that fails one or more items was given a grade of “C”.

### [Gas Shielded Arc Welding (for Weld Metal Evaluation)]

Welding was performed for weld metal evaluation. Specifically, a groove angle of SM490A steel materials described in JIS G3106:2020 and having a plate thickness of 12 mm were processed to 45°, and the inside of the groove and a backing metal were buttered in two or more layers using the produced solid wire, and then the weld metal was formed by multi-layer welding using TIG welding with a root spacing of 6.5 mm. Welding conditions are as follows.

### <Welding Conditions>

Welding method: TIG welding
Wire diameter: 1.2 mm
Welding current: 160 A to 180 A
Arc voltage: 10 V to 16 V
Shielding gas type and flow rate: 100% Ar, 25 L/min
Welding position: Flat
PWHT temperature and time: 745° C., 1 hour

### [Mechanical Performance Evaluation Test of Weld Metal]

### <Transformation Point Measurement Test>

A round bar-shaped test piece having a diameter of 8 mm and a length of 12 mm was taken from the obtained weld metal, and the Ac1 transformation point was measured by measuring a volume change of the test piece during heating by high-frequency induction heating.

Note that when PWHT is performed at a temperature higher than the Ac1 transformation point, the weld metal undergoes reverse transformation to form a structure containing fresh martensite, which has high strength and low toughness, and the performance of the weld joint deteriorates. Therefore, a higher Ac1 transformation point allows for a larger tolerance in the temperature setting for PWHT. Therefore, as evaluation criteria, those with an Ac1 transformation point of 800° C. or higher were rated as “A” (excellent); those with an Ac1 transformation point of 760° C. or higher and less than 800° C. were rated as “B” (good); and those with an Ac1 transformation point of less than 760° C. were rated as “C” (poor).

### <Tensile Strength Test>

A tensile test piece having a diameter of 6 mm and a gauge length of 24 mm was taken from a center in a plate thickness direction of the obtained weld metal parallel to a welding direction, and a room temperature tensile strength (TS) of the weld metal was measured in accordance with a tensile test method for metal materials described in JIS Z 2241:2011.

Note that if the strength of the weld metal is excessive, sulfide stress corrosion cracking may occur. If the strength of the weld metal is insufficient, a structure with a desired strength cannot be manufactured. Therefore, as the evaluation criteria, a tensile strength test result of 600 MPa or more and 720 MPa or less was rated as “A” (excellent), a result of 550 MPa or more and less than 600 MPa, or more than 720 MPa and 780 MPa or less was rated as “B” (good), and a result of less than 550 MPa or more than 780 MPa was rated as “C” (poor).

### <Charpy Impact Test>

A 2 mm V-notch Charpy impact test piece was taken perpendicular to the welding direction from the center in the plate thickness direction of the obtained weld metal, and the Charpy impact value under −30° C. or −40° C. was measured in accordance with the Charpy impact test method for metal materials described in JIS Z 2242:2005.

Note that as the evaluation criteria for toughness based on the Charpy impact value, the Charpy impact value, which is obtained by dividing an absorbed energy measurement result measured in the Charpy impact test under −30° C. or less by an original cross-sectional area of a notch, of 47 (J/cm²) or more was rated as “A” (excellent), and the Charpy impact value of 27 (J/cm²) or more and less than 47 (J/cm²) was rated as “B” (good), and the Charpy impact value of less than 27 (J/cm²) was rated as “C” (poor).

Measurement results of each evaluation test are shown in Table 3 below, and evaluation results are shown in Table 4 below.

TABLE 1

| | | Content (mass %) of chemical components based on total mass of wire | | | | | | | | | | | | | | | |
|---|---|---|---|---|---|---|---|---|---|---|---|---|---|---|---|---|---|
| No. | | C | Si | Mn | S | Cr | Mo | P | Ni | Nb | V | Ti | Al | Zr | Co | Cu | N |
| Inventive | A1 | 0.03 | 1.33 | 0.57 | 0.007 | 5.85 | 0.53 | 0.004 | <0.01 | <0.005 | <0.01 | 0.003 | <0.002 | — | — | 0.15 | <0.02 |
| Example | A2 | 0.05 | 1.37 | 0.59 | 0.007 | 5.80 | 0.53 | 0.004 | <0.01 | <0.005 | <0.01 | 0.002 | <0.002 | — | — | 0.15 | <0.02 |
| | A3 | 0.07 | 1.10 | 0.70 | 0.011 | 5.39 | 0.51 | 0.005 | 0.40 | <0.005 | <0.01 | <0.002 | 0.003 | 0.056 | <0.003 | 0.14 | <0.02 |
| | A4 | 0.06 | 1.20 | 0.51 | 0.008 | 5.18 | 0.51 | <0.003 | 0.31 | <0.005 | <0.01 | <0.002 | <0.002 | 0.080 | <0.003 | <0.01 | <0.02 |
| | A5 | 0.06 | 1.18 | 0.51 | 0.008 | 5.18 | 0.51 | <0.003 | 0.61 | <0.005 | <0.01 | <0.002 | <0.002 | 0.083 | <0.003 | <0.01 | <0.02 |
| | A6 | 0.07 | 1.56 | 0.76 | 0.012 | 4.99 | 0.51 | 0.003 | 0.40 | <0.005 | <0.01 | <0.002 | 0.003 | 0.057 | — | 0.15 | <0.02 |
| | A7 | 0.05 | 1.19 | 0.52 | 0.012 | 9.11 | 0.99 | 0.003 | <0.01 | <0.005 | <0.01 | 0.005 | <0.002 | — | — | <0.01 | <0.02 |
| | A8 | 0.07 | 1.31 | 0.65 | 0.011 | 10.91 | 1.12 | 0.004 | <0.01 | <0.005 | <0.01 | 0.003 | <0.002 | — | — | <0.01 | <0.02 |
| | A9 | 0.07 | 1.21 | 0.62 | 0.008 | 8.68 | 0.98 | <0.003 | 0.61 | <0.005 | <0.01 | <0.002 | <0.002 | — | <0.003 | <0.01 | <0.02 |
| | A10 | 0.07 | 0.84 | 0.62 | 0.008 | 8.67 | 0.98 | <0.003 | 0.21 | <0.005 | <0.01 | <0.002 | <0.002 | 0.034 | <0.003 | <0.01 | <0.02 |
| | A11 | 0.07 | 0.84 | 0.62 | 0.008 | 8.66 | 0.97 | <0.003 | 0.21 | <0.005 | <0.01 | <0.002 | <0.002 | 0.092 | <0.003 | <0.01 | <0.02 |
| | A12 | 0.05 | 1.19 | 0.60 | 0.007 | 8.66 | 0.98 | <0.003 | 0.62 | <0.005 | <0.01 | <0.002 | <0.002 | 0.080 | <0.003 | <0.01 | <0.02 |
| | A13 | 0.07 | 1.20 | 0.61 | 0.008 | 8.68 | 0.98 | <0.003 | 0.62 | <0.005 | <0.01 | <0.002 | <0.002 | 0.080 | <0.003 | <0.01 | <0.02 |
| | A14 | 0.09 | 1.09 | 0.70 | 0.011 | 8.88 | 0.94 | 0.004 | 0.42 | <0.005 | <0.01 | <0.002 | 0.004 | 0.059 | — | <0.01 | <0.02 |
| | A15 | 0.10 | 1.19 | 0.60 | 0.007 | 8.70 | 0.98 | <0.003 | 0.61 | <0.005 | <0.01 | <0.002 | <0.002 | 0.076 | <0.003 | <0.01 | <0.02 |
| | A16 | 0.09 | 1.55 | 0.70 | 0.01 | 8.52 | 0.97 | 0.003 | 0.40 | <0.005 | <0.01 | <0.002 | 0.004 | 0.061 | <0.003 | <0.01 | <0.02 |

TABLE 2

| | | Content (mass %) of chemical components based on total mass of wire | | | | | | | | | | | | | | | |
|---|---|---|---|---|---|---|---|---|---|---|---|---|---|---|---|---|---|
| No. | | C | Si | Mn | S | Cr | Mo | P | Ni | Nb | V | Ti | Al | Zr | Co | Cu | N |
| Comparative | B1 | 0.05 | 0.40 | 0.50 | 0.007 | 5.59 | 0.55 | 0.003 | <0.01 | <0.005 | <0.01 | <0.002 | <0.002 | — | — | 0.15 | <0.02 |
| Example | B2 | 0.07 | 2.70 | 0.63 | 0.011 | 5.61 | 0.52 | 0.003 | 0.30 | <0.005 | <0.01 | <0.002 | 0.002 | 0.043 | — | 0.16 | <0.02 |
| | B3 | 0.07 | 0.39 | 0.52 | 0.01 | 9.03 | 1.00 | 0.003 | <0.01 | <0.005 | <0.01 | 0.004 | <0.002 | — | — | <0.01 | <0.02 |
| | B4 | 0.07 | 0.50 | 0.61 | 0.007 | 8.73 | 0.98 | <0.003 | 0.21 | <0.005 | <0.01 | <0.002 | <0.002 | 0.033 | <0.003 | <0.01 | <0.02 |
| | B5 | 0.07 | 0.50 | 0.62 | 0.008 | 8.69 | 0.98 | <0.003 | 0.21 | <0.005 | <0.01 | <0.002 | <0.002 | 0.087 | <0.003 | <0.01 | <0.02 |
| | B6 | 0.07 | 1.99 | 0.61 | 0.011 | 9.40 | 1.01 | 0.003 | 0.30 | <0.005 | <0.01 | <0.002 | <0.002 | 0.049 | — | <0.01 | <0.02 |
| | B7 | 0.07 | 2.65 | 0.61 | 0.01 | 9.47 | 1.01 | 0.003 | 0.30 | <0.005 | <0.01 | <0.002 | <0.002 | 0.051 | — | <0.01 | <0.02 |
| | B8 | 0.12 | 1.33 | 0.94 | 0.011 | 8.71 | 0.96 | 0.003 | 0.80 | <0.005 | <0.01 | <0.002 | <0.002 | 0.057 | <0.003 | <0.01 | <0.02 |
| | B9 | 0.12 | 1.28 | 0.91 | 0.011 | 8.80 | 0.96 | <0.003 | 1.50 | <0.005 | <0.01 | <0.002 | <0.002 | 0.058 | <0.003 | <0.01 | <0.02 |
| | B10 | 0.12 | 1.32 | 1.62 | 0.011 | 8.78 | 0.96 | <0.003 | 0.80 | <0.005 | <0.01 | <0.002 | <0.002 | 0.067 | <0.003 | <0.01 | <0.02 |

TABLE 3

| | | Measurement results | | | | | | | |
|---|---|---|---|---|---|---|---|---|---|
| | | Weld metal | | | | Back bead | | | |
| | | | | Measurement | | | | | Shape of |
| | | | | temperature | Charpy | | Back | | boundary |
| | | Ac1 | Tensile | (° C.) | impact | | bead | | between base |
| | | transformation | strength | of Charpy | value | Back bead | height | Depression | material and |
| No. | | point (° C.) | TS (MPa) | impact test | (J/cm²) | appearance | (mm) | depth (mm) | Back bead |
| Inventive | A1 | 824 | 554 | −40 | 295 | Good | 2 | 0 | Good |
| Example | A2 | 809 | 618 | −40 | 238 | Good | 1 | 0 | Good |
| | A3 | 790 | 674 | −30 | 90 | Good | 1 | 0 | Good |
| | A4 | 805 | 638 | −30 | 191 | Good | 1 | 0 | Good |
| | A5 | 803 | 652 | −30 | 140 | Good | 1 | 0 | Good |
| | A6 | 795 | 696 | −30 | 66 | Good | 1 | 0 | Good |
| | A7 | 832 | 577 | −40 | 37 | Good | 2 | 0 | Good |
| | A8 | 835 | 678 | −40 | 92 | Good | 1 | 0 | Good |
| | A9 | 802 | 723 | −30 | 196 | Good | 3 | 0 | Good |
| | A10 | 820 | 667 | −30 | 217 | Good | 2 | 0 | Good |
| | A11 | 822 | 663 | −30 | 131 | Good | 1 | 0 | Good |
| | A12 | 812 | 650 | −30 | 150 | Good | 3 | 0 | Good |
| | A13 | 817 | 705 | −30 | 53 | Good | 3 | 0 | Good |
| | A14 | 789 | 717 | −30 | 40 | Good | 2 | 0 | Good |
| | A15 | 812 | 747 | −30 | 48 | Good | 1 | 0 | Good |
| | A16 | 815 | 770 | −30 | 54 | Good | 1 | 0 | Good |
| Comparative | B1 | 795 | 551 | −30 | 288 | Burn-through | 1 | 0.5 | Poor |
| Example | B2 | 863 | 738 | −30 | 5 | Good | 1 | 0 | Good |
| | B3 | 811 | 647 | −30 | 330 | Burn-through | 5 | 0 | Poor |
| | B4 | 810 | 643 | −30 | 250 | Burn-through | 2 | 0 | Poor |
| | B5 | 812 | 646 | −30 | 126 | Burn-through | 3 | 0 | Poor |
| | B6 | 861 | 724 | −30 | 5 | Good | 1 | 0 | Good |
| | B7 | >900 | 725 | −30 | 10 | Good | 1 | 0 | Good |
| | B8 | 788 | 821 | −30 | 34 | Good | 2 | 0 | Good |
| | B9 | 749 | 847 | −30 | 21 | Good | 2 | 0 | Good |
| | B10 | 758 | 823 | −30 | 24 | Back bead | 2 | 0 | Good |
| | | | | | | oxidation | | | |

TABLE 4

| | | Evaluation results | | | |
|---|---|---|---|---|---|
| | | Weld metal | | | |
| | | Ac1 transfor- | Tensile | | Back bead |
| No. | | mation point | strength | Toughness | Back bead |
| Inventive | A1 | A | B | A | A |
| Example | A2 | A | A | A | A |
| | A3 | B | A | A | A |
| | A4 | A | A | A | A |
| | A5 | A | A | A | A |
| | A6 | B | A | A | A |
| | A7 | A | B | B | A |
| | A8 | A | A | A | A |
| | A9 | A | B | A | A |
| | A10 | A | A | A | A |
| | A11 | A | A | A | A |
| | A12 | A | A | A | A |
| | A13 | A | A | A | A |
| | A14 | B | A | B | A |
| | A15 | A | B | A | A |
| | A16 | A | B | A | A |
| Comparative | B1 | B | B | A | C |
| Example | B2 | A | B | C | A |
| | B3 | A | A | A | C |
| | B4 | A | A | A | C |
| | B5 | A | A | A | C |
| | B6 | A | B | C | A |
| | B7 | A | B | C | A |
| | B8 | B | C | B | A |
| | B9 | C | C | C | A |
| | B10 | C | C | C | C |

### [Evaluation Results]

As shown in Tables 1 to 4 above, in Inventive Example Nos. A1 to A16, the chemical components of the solid wires were within the numerical ranges defined in the present invention, so that it was possible to obtain back beads with excellent appearance without using a backing gas, and to obtain weld metals with excellent mechanical performance.

On the other hand, in Comparative Example Nos. B1 and B3 to B5, the contents of Si in the solid wires were below the lower limit of the numerical range defined in the present invention, and therefore the evaluation results of the back beads were poor. In Comparative Example Nos. B2, B6 and B7, the contents of Si in the solid wires exceeded the upper limit of the numerical range defined in the present invention, and therefore the toughness evaluation results thereof were poor. In Comparative Example No. B8, the content of C in the solid wire exceeded the upper limit of the numerical range defined in the present invention, and therefore the strength of the weld metal became excessive, and the probability of occurrence of sulfide stress cracking increased.

In Comparative Example No. B9, the content of C and the content of Ni in the solid wire exceeded the upper limit of the numerical range defined in the present invention, and therefore the strength of the weld metal became excessive, the toughness decreased, and the transformation point decreased, making it difficult to perform PWHT at a high temperature. In Comparative Example No. B10, the content of C and the content of Mn in the solid wire exceeded the upper limit of the numerical range defined in the present invention, and therefore the strength of the weld metal became excessive, the toughness decreased, and the transformation point decreased, performing PWHT at a high temperature became difficult, and poor formation of back beads was caused.

Note that although the above-mentioned Inventive Example Nos. Al to A16 are examples in which steel plates with a high content of Cr, which are generally difficult to form good back beads, were welded together, good evaluation results were obtained without using a backing gas by using solid wires having compositions within the numerical range specified in the present invention. Accordingly, it is shown that even when the content of Cr of at least one of the steel materials to be welded is 4 mass % or more and 10 mass % or less, and the content of Cr of the other steel material is, for example, 10 mass % or less (including 0 mass %), it is still possible to obtain a good weld metal without using a backing gas. In welding steel plates with a content of Cr of 5 mass % to 10 mass %, the poor appearance of the back beads is caused by the high content of Cr of the steel plates and welding materials, and therefore, the solid wire of the present embodiment can also be applied to a case where the content of Cr of one of the steel materials used as the steel materials to be welded is less than 4 mass %.

Although various embodiments are described above, it is needless to say that the present invention is not limited to these embodiments. It is apparent that those skilled in the art can conceive of various modifications and alterations within the scope described in the claims, and it is understood that such modifications and alterations naturally fall within the technical scope of the present invention. In addition, the respective constituent elements in the above-described embodiments may be freely combined without departing from the gist of the invention.

Note that the present application is based on a Japanese Patent Application (Patent Application No. 2022-142294) filed on Sep. 7, 2022, contents of which are incorporated herein by reference.

1. A solid wire suitable for welding steel materials, the solid wire comprising, based on a total mass of the wire:
C: 0.02 mass % or more and 0.11 mass % or less;
Si: 0.6 mass % or more and 1.7 mass % or less;
Mn: 0.2 mass % or more and 1.5 mass % or less;
S: more than 0.005 mass % and 0.030 mass % or less;
Cr: 4.0 mass % or more and 13 mass % or less;
Mo: 0.3 mass % or more and 1.5 mass % or less;
P: 0.030 mass % or less;
Ni: 1.4 mass % or less;
Nb: 0.05 mass % or less;
V: 0.05 mass % or less;
Ti: 0.05 mass % or less;
Al: 0.05 mass % or less; and
Fe,
wherein at least one of the steel materials comprises from 4 mass % to 10 mass % of Cr.

2. The solid wire according to claim 1, further comprising, based on the total mass of the wire:
Zr: 0.15 mass % or less.

3. The solid wire according to claim 1, further comprising:
at least one selected from Co, Cu, and N in ranges of, based on the total mass of the wire,
Co: 0.5 mass % or less,
Cu: 0.5 mass % or less, and
N: 0.02 mass % or less.

4. A gas shielded arc welding method, comprising:
welding steel materials, at least one of which comprises 4 mass % or more and 10 mass % or less of Cr, with the solid wire according to claim 1, without using a backing gas.

5. A gas shielded arc welding method, comprising:
welding steel materials, at least one of which comprises 4 mass % or more and 10 mass % or less of Cr, with the solid wire according to claim 3, without using a backing gas.

6. The solid wire according to claim 2, further comprising:
at least one selected from Co, Cu, and N in ranges of, based on the total mass of the wire,
Co: 0.5 mass % or less,
Cu: 0.5 mass % or less, and
N: 0.02 mass % or less.

7. A gas shielded arc welding method, comprising:
welding steel materials to be welded, at least one of which comprises 4 mass % or more and 10 mass % or less of Cr, with the solid wire according to claim 2, without using a backing gas.
